(19) United States
(12) Patent Application Publication
(10) Pub. No.: US 2024/0303729 A1
(43) Pub. Date: Sep. 12, 2024

(54) CUSTOMER CONTACT CHANNEL OPTIMIZATION

(71) Applicant: Wells Fargo Bank, N.A., San Francisco, CA (US)

(72) Inventors: Aniket Dhawad, Bangalore (IN); Rama Kishore Darlapudi, Bangalore (IN); Arun Govind, Bangalore (IN); Ramesh Babu Sarvesetty, Bangalore (IN); Dian Song, Eden Prairie, MN (US); Nakul Bharadwaj, Charlotte, NC (US)

(21) Appl. No.: 18/181,373

(22) Filed: Mar. 9, 2023

(51) Int. Cl. G06Q 40/03; G06Q 30/016

(52) U.S. Cl. CPC G06Q 40/03; G06Q 30/016

(57) ABSTRACT

Techniques described herein include identifying an appropriate and/or optimal way to communicate with a credit customer, customer, or debtor. In one example, this disclosure describes a method that includes receiving, by a computing system, state information for a debtor, wherein the state information includes information about delinquency history for the debtor and prior efforts to contact the debtor to collect a delinquent debt; identifying, based on the state information for the debtor, a communication channel to use to contact the debtor about the delinquent debt, initiating contact with the debtor through the identified communication channel; storing data identifying how the debtor reacted to the initiated contact through the identified communication channel; and determining whether to initiate further communications with the debtor about the delinquent debt.

### TECHNICAL FIELD

This disclosure relates to computing systems, and more specifically, to techniques for identifying an optimal communication channel to use when communicating with another computing system, entity, or person.

### BACKGROUND

Debt collection is a common practice that spans almost every type of business. A variety of strategies are employed to collect debts, including debts that are delinquent (e.g., where the debtor has failed to make a minimum payment before a due date). Most strategies for collecting delinquent debts involve the creditor attempting to engage in some form of communication with the debtor. However, communicating with debtors is time-consuming, inefficient, and often unproductive.

### SUMMARY

Techniques described herein include identifying an appropriate and/or optimal way to communicate with a credit customer, customer, or debtor (hereinafter “debtor”). In particular, techniques described herein involve predicting the optimal communication channel to use in order to communicate with a debtor and thereby prompt a desired response from the debtor. The optimal response, in most cases, involves receiving payment for the delinquent debt. However, other responses are productive, such as establishing communications with the debtor or prompting the debtor to check the online status of his or her account.

In some cases, collecting a delinquent debt may require multiple attempts at communication with the debtor. Techniques described herein involve identifying, for each new attempt to communicate with the debtor, the next best channel to use when contacting the debtor, where that next best channel offers the highest odds of receiving a payment or at least prompting a productive reaction by the debtor.

As described herein, techniques are employed that are capable of developing insight into delinquent debtors and how to productively communicate with them. Such techniques may also involve effective selection of a communication channel from among multiple possible communication channels, even where some of those channels might be blocked by the debtor or by other circumstances. Techniques described herein enable an understanding of which channels have a positive impact and which seem to have a negative impact.

Although techniques described herein are primarily described in the context of collecting delinquent debts, the same or similar techniques may be used to target non-delinquent debtors with reminder messages. Similarly, techniques described herein may reward debtors that tend to pay debts quickly and reliably.

In some examples, this disclosure describes operations performed by a computing system in accordance with one or more aspects of this disclosure. In one specific example, this disclosure describes a method comprising receiving, by a computing system, state information for a debtor, wherein the state information includes information about delinquency history for the debtor and prior efforts to contact the debtor to collect a delinquent debt; identifying, by the computing system and based on the state information for the debtor, a communication channel to use to contact the debtor about the delinquent debt, wherein the communication channel is one of a plurality of communication channels that could be used to contact the debtor; initiating contact with the debtor, by the computing system, through the identified communication channel; storing data, by the computing system, identifying how the debtor reacted to the initiated contact through the identified communication channel; and determining, by the computing system, whether to initiate further communications with the debtor about the delinquent debt.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for communicating with borrowers, lending customers, credit customers, and/or debtors in an appropriate manner, in accordance with one or more aspects of the present disclosure.

FIG. 2A is a conceptual diagram illustrating an example system that uses a reinforcement learning model to predict the most appropriate way to communicate with debtors, in accordance with one or more aspects of the present disclosure.

FIG. 2B is a flow diagram illustrating an example process for performing reinforcement learning tasks described in connection with FIG. 2A, in accordance with one or more aspects of the present disclosure.

FIG. 2C is a flow diagram illustrating an example process for initial training of a reinforcement learning agent, in accordance with one or more aspects of the present disclosure.

FIG. 2D is a flow diagram illustrating an example periodic process for updating a reinforcement learning agent, in accordance with one or more aspects of the present disclosure.

FIG. 2E is a flow diagram illustrating an example periodic process for choosing an action to take for each of a plurality of debtors, in accordance with one or more aspects of the present disclosure.

FIG. 3 is a block diagram illustrating an example system for communicating with debtors in an optimal way, in accordance with one or more aspects of the present disclosure.

FIG. 4 is a flow diagram illustrating operations performed by an example computing system in accordance with one or more aspects of the present disclosure.

### DETAILED DESCRIPTION

Creditors and/or debt collectors tend to use several communication channels to contact delinquent debtors in order to avoid charge-offs (i.e., losses incurred by creditor). These practices tend to apply in some faction to any type of debt (e.g., credit cards, loans, and others). Typically, debt collectors tend to communicate with debtors over multiple channels frequently and sometimes simultaneously, without a coherent strategy. Often, there is little or no effort made to identify the most appropriate channel to use when communicating with a given debtor, and creditors often spend significant amounts of money and resources trying to contact debtors through sub-optimal channels, resulting in reduced efficiency. These efforts not only tend to be unproductive, but also tend to alienate the debtor and harm the reputation of the creditor.

It would be more efficient and require significantly less resources if the debt collector could accurately identify the “best” communication channel to use in order to contact a debtor, where that “best” channel tends to offer the highest odds of receiving a payment. After each communication, if no payment on the debt is made, it would also be productive to identify the “next best” channel used to use when communicating with the debtor. Depending on the circumstances and the debtor, that “next best” communication channel may be different than the prior communication channel.

Accordingly, for each communication with a debtor, the debt collector should reconsider the question of which is the most appropriate communication channel to use, of the available communication channels, in order to effectively communicate with a debtor. Selecting the most appropriate channel can be important, since debtors who receive targeted communications on the most appropriate communications channel early in the debt collection process tend to spend less time in delinquency.

In some examples herein, machine learning techniques are used to identify the next best channel to use in order to contact a debtor. In particular, reinforcement learning techniques may be particularly appropriate for predicting the best communication channel to use when contacting a debtor. Other machine learning techniques, such as supervised learning, may be of some use in predicting the next best channel, but supervised learning methods tend to optimize only one immediate interaction with a debtor, rather than a sequence of potentially dependent communications with a debtor. Supervised learning approaches therefore might not be a good approximation of real customer or debtor journeys that generally consist of multiple related interactions that can be jointly optimized with longer-term objectives in mind. Supervised learning systems may learn the best action to take based on information gathered from prior strategies, but such systems might not be well equipped to go beyond prior strategies and explore previously unexplored (but possibly effective) actions and sequences. Also, with supervised learning techniques, reacting to changes in debtor preferences over time tends to require retraining the model, and retraining can be a tedious task in supervised learning.

In addition, for at least some of the scenarios addressed in this disclosure, the training data available is not exhaustive. And even the available data tends to be derived from historical, and possibly flawed, strategies used by human debt collectors. Such strategies may be plagued by selection bias, and therefore might not be ineffective if used in a system that employs supervised learning.

Reinforcement learning techniques, however, can maximize long-term rewards and potentially improve upon conventional and/or historical strategies. Reinforcement learning techniques can also continuously learn and adapt to perform optimal actions based on rewards granted in exchange for productive actions and, possibly, penalties exacted for unproductive actions. Problems with insufficient data and historical selection biases tend to be avoided using techniques described herein.

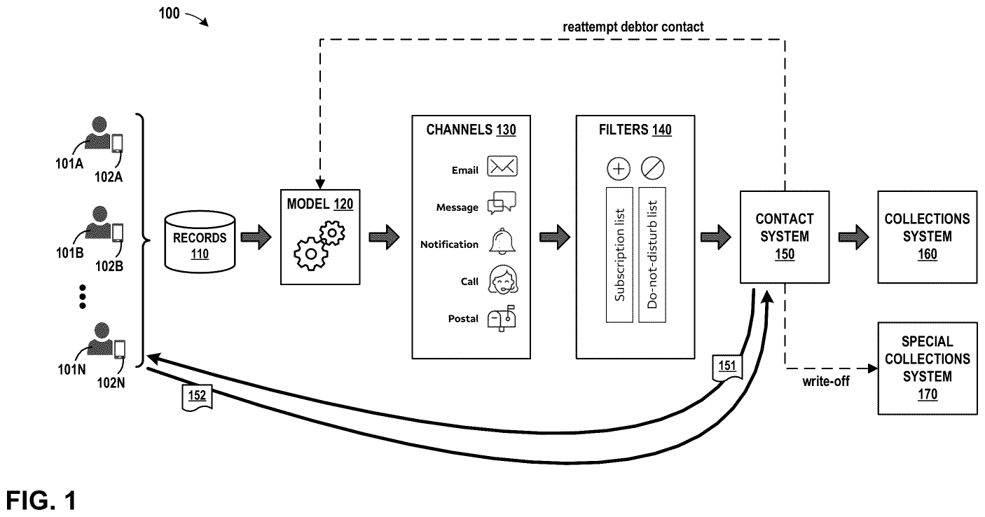

FIG. 1 is a conceptual diagram illustrating an example system for communicating with borrowers, lending customers, credit customers, and/or debtors in an appropriate manner, in accordance with one or more aspects of the present disclosure. Illustrated on the left side of FIG. 1 are debtors 101A, 101B, through 101N (“debtors 101”), each representing a credit customer for a financial institution, bank, or any commercial entity that may extend credit to customers. Each of debtors 101 controls and/or operates one or more debtor devices 102 (i.e., debtor devices 102A through 102N, operated by corresponding debtors 101A through 101N). Often, debtor devices 102 are mobile communications devices or smartphones. However, debtor devices 102 may be implemented through any suitable computing system including any mobile, non-mobile, wearable, and/or non-wearable computing device. In general, debtor devices 102 may take any appropriate form, which may include a mobile phone or tablet, a laptop or desktop computing device, a computerized watch, a computerized glove or gloves, a personal digital assistant, a virtual assistant, a gaming system, a media player, an e-book reader, a television or television platform, a bicycle, automobile, or navigation, information and/or entertainment system, or any other type of wearable, non-wearable, mobile, or non-mobile computing device that may perform operations in accordance with one or more aspects of the present disclosure.

System 100 of FIG. 1 includes a number of conceptual systems, including records data store 110, model 120, communication channels 130, filter systems 140, contact system 150, collection system 160, and special collections system 170. System 100 may be operated and/or used by a bank or financial institution as a way of communicating with each of debtors 101, who may be credit customers of the bank or financial institution. In this disclosure, communications with debtors 101 are typically in the context of attempting to collect a debt (often a delinquent debt) that one or more of debtors 101 owes to the bank, financial institution, or other creditor.

Records data store 110 includes information about each of debtors 101, including information about bank accounts, credit accounts, contact information, customer profile information, delinquency information, previous communications, or any other information that a bank, financial institution, or other creditor may maintain about its customers.

Model 120 is a system that analyzes information included within records data store 110 and chooses an appropriate communication channel through which to communicate with each of debtors 101. As further described herein, model 120 may be an artificially intelligent system, and in at least some examples, may be implemented as a model trained using reinforcement learning techniques.

Communication channels 130 represent a selection of available ways to communicate with debtors 101, and may include email, text messaging, mobile application-based notifications, phone calls, physical mail deliver, or other channels.

Filter system 140 may modify or override choices made by model 120. In some cases, policies of the bank, financial institution, or a bank line of business may mandate that some communication channels 130 are not available to be used for contacting certain debtors 101.

Similarly, various regulatory or other requirements may also limit the use of communication channels 130 in some cases.

Contact system 150 is used to carry out communications with debtors 101 (or debtor devices 102) through any of the communication channels 130. Collection system 160 represents systems that may be required to finalize or complete collection of a debt, such as accounting systems, data storage systems, and/or systems that communicate with credit reporting agencies.

Special collections system 170 represents systems that may support loss or charge-off processing, such as when a debt held by one of debtors 101 is designated as uncollectible. Both collection system 160 and/or special collections system 170 may also encompass accounting systems, data storage systems, and/or systems that communicate with credit reporting agencies.

Each of the illustrated systems and/or components of system 100 in FIG. 1 may be implemented as any suitable computing system or collection of computing systems, including one or more server computers, workstations, mainframes, appliances, cloud computing systems, and/or other computing devices that may be capable of performing operations and/or functions described in accordance with one or more aspects of the present disclosure. In some examples, such systems may represent or be implemented through one or more virtualized compute instances (e.g., virtual machines, containers) of a distributed data center, cloud computing system, server farm, and/or server cluster. Also, although various systems and/or components of system 100 are illustrated separately, one or more of such systems could be combined and operate as a single system.

With reference to FIG. 1, and in accordance with one or more aspects of the present disclosure, model 120 may choose a communication channel for one of debtors 101. For instance, in an example that can be described in the context of FIG. 1, model 120 receives information about a debt held by a specific debtor 101, such as debtor 101N. Typically, the debt may be a delinquent debt. Model 120 may receive the information about the debt from a bank, financial institution, or other creditor (not specifically shown in FIG. 1). In some examples, model 120 may access additional information about the debt and/or debtor 101N in records data store 110. Based on the information available to model 120 about the debt and/or debtor 101N, model 120 chooses the most appropriate or optimal communication channel 130 to use to contact debtor 101N. In some examples, model 120 generates a ranking of available communication channels 130 (or alternatively, a score for each of the available contact channels). In the specific example being described, model 120 ranks “text messaging” as the most appropriate channel to use when contacting debtor 101N, followed by “email” as the next-most appropriate channel.

Filter system 140 may modify the chosen communication channel. For instance, continuing with the example being described in the context of FIG. 1, model 120 outputs its ranking of communication channels 130 to filter system 140. Filter system 140 processes the ranking of communication channels 130 to adjust for any subscription lists, do-not-disturb lists, communication policies employed by the creditor, regulatory requirements, or other circumstances that may affect how debtor 101N can or should be contacted. Debtor 101N may, for example, be listed on a “do not text” list, and if so, filter system 140 modifies the ranking of communication channels 130 to remove “text messaging” from the ranked list of communication channels 130 for debtor 101N. Since the ranked list of communication channels 130, as generated by model 120 in the example being described, rated text messaging as the best communication channel to use for contacting debtor 101N, filter system 140 moves the next most appropriate channel (email) to the top of the list in the ranking of communication channels 130 for debtor 101N.

Contact system 150 may initiate contact with debtor 101N. For instance, still continuing with the example being described in the context of FIG. 1, filter system 140 outputs the modified ranking of communication channels 130 for debtor 101N to contact system 150. Contact system 150 evaluates the ranked list and interprets the list as a command to send an email to debtor 101N (the “text messaging” channel was removed from the list by filter system 140). Contact system 150 outputs communication 151 over a network in the form of an email destined for debtor device 102N (debtor device 102N is possessed and/or operated by debtor 101N). Debtor device 102N receives communication 151 and presents information about the debt to debtor 101N. Preferably, debtor 101N sees the information about the debt included in the email and responds by paying the debt. In that situation, contact system 150 outputs information to collection system 160 enabling the collection on the debt to be completed and/or finalized.

Thereafter, in that situation, no further communications with debtor 101N are needed about the debt.

In other examples, however, debtor 101N might not pay the debt, but may respond to communication 151 with responsive communication 152. Or in some cases, debtor 101N may simply ignore communication 151. In those situations, contact system 150 updates records data store 110 with information about whether debtor 101N responded to communication 151 (and if so, contact system 150 may include in records data store 110 information about the response).

Thereafter, contact system 150 communicates with model 120, requesting that model 120 generate a new ranking of communication channels 130 to use when attempting to contact debtor 101N again. In response, model 120 identifies which of communication channels 130 is the next best channel to continue communicating with debtor 101N, and generates a new ranking of communication channels 130. That ranking may also be thereafter filtered by filter system 140 and output to contact system 150. Contact system 150 interprets the filtered ranking and sends a new communication 151 to debtor 101N using the new top-ranked communication channel, which may be different than previous channels used to contact debtor 101N. In response to the new communication 151, debtor 101N may pay the debt, respond in some way, or ignore the new communication 151.

This process of repeatedly contacting debtor 101N continues until the debt is paid by debtor 101N or until sufficient communications with debtor 101N have occurred to indicate that the debt held by debtor 101N should be characterized as uncollectible. At that point, communications with debtor 101N may cease, and contact system 150 may output information to special collections system 170 indicating that the debt should be moved to a “difficult-to-collect” phase, or written off as a loss. A similar process may be performed for each of debtors 101 individually, so that each debtor 101 is treated in a unique way based on attributes unique to each debtor 101 and previous communications with each debtor 101. The result is a customized process for communication that takes into account customer and creditor preferences, preferred communication channels, regulatory requirements, and account and/or delinquency history.

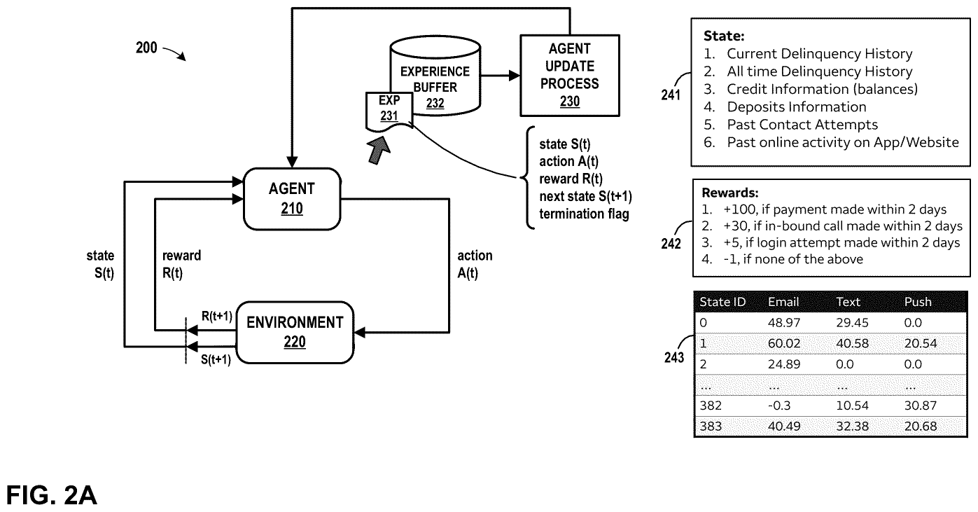

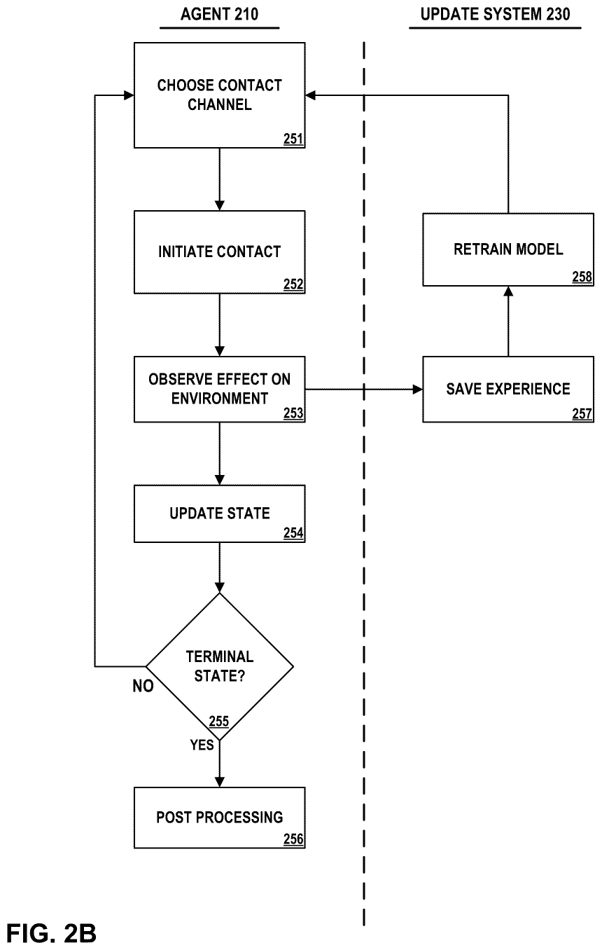

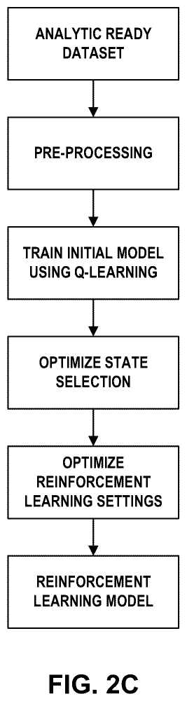

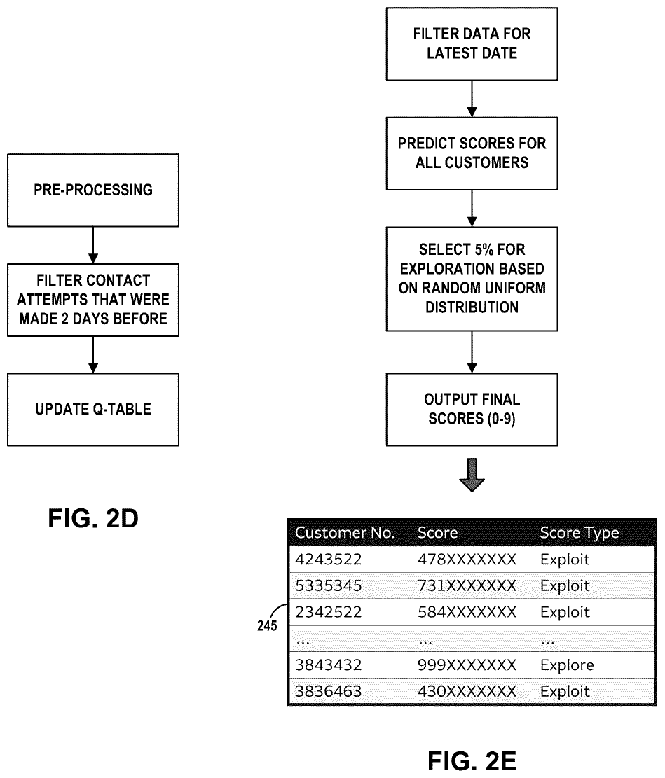

FIG. 2A is a conceptual diagram illustrating an example system that uses a reinforcement learning model to predict the most appropriate way to communicate with debtors, in accordance with one or more aspects of the present disclosure. FIG. 2A illustrates an example implementation of model 120 of FIG. 1 where reinforcement learning techniques are used to implement model 120 of FIG. 1. Reinforcement learning techniques may be used to enable model 120 to predict the next best communication channel to use when contacting one or more debtors 101 during a debt collection process.

Illustrated in FIG. 2A is a reinforcement learning state diagram, which is often used to describe and illustrate a Markov decision process forming the basis for a reinforcement learning model. In FIG. 2A, agent 210 receives as input, at time “t,” a state S(t) for a particular debtor (e.g., debtor 101N of FIG. 1) and a reward R(t) associated with that state. In response, agent 210 predicts the optimal action A(t) to be taken at time “t,” where the “optimal action” could be defined, for at least some examples described in this disclosure, as the action that is most likely to prompt a given debtor to pay an outstanding credit balance. Actions in such an example would involve contacting a given delinquent debtor 101 through any of a number of available channels, and may include sending an email to that debtor 101, sending a text message, sending a push notification in a banking application that debtor 101 uses, making a phone call to 101, or any of a number of other actions.

The action taken by agent 210 has an effect on environment 220, and causes environment 220 to be transitioned to a new state S(t+1) at time “t+1,” and where that new state has associated with it a new reward (i.e., R(t+1)). Agent 210 in FIG. 2A then repeats the process for the new state at time t+1. At each time “t,” agent 210 determines a predicted “optimal action” for each state, performs the action, and thereby causes an effect on environment 220. The process continues until a termination condition is reached, such as a debt being collected from the specific debtor 101 being targeted by the communications. Other conditions may also cause the process or episode to terminate, such as the debtor 101 being classified as “uncollectable” by the bank or other creditor.

State definition 241, as shown in FIG. 2A, outlines one possible way to define the state of a debtor 101. Typically, the state of a debtor 101 includes attributes pertaining to the goal sought to be reached. In the context of this disclosure, such a goal may be prompting debtor 101 to pay a delinquent credit account. Accordingly, the state of a debtor 101 may be defined in terms of the current and past delinquency history of that debtor 101, and also in terms of the debtor's credit and deposit information. The state may also be defined in terms of information about past attempts to contact debtor 101 (see state definition 241).

Depending on how system 200 is implemented, state variables could include number of days in delinquency, credit utilization, lifetime delinquency cycle count, application logins in the past 30 days, last successful digital channel, last unsuccessful digital channel, and/or number of consecutive unsuccessful attempts using the last channel. The first four of these variables are action independent, and the last three variables are action-dependent. Action independent variables include those that are not impacted by model's action (e.g., delinquency bucket, account balance, total credit balance, total debit balance). Action dependent variables are those that are impacted by model's action. For example, the last unsuccessful contact channel is action-dependent. It may be important to have action dependent variables in the state definition, to ensure that the state of the debtor and/or environment changes after each contact attempt, even if there are no changes in the action independent variables.

To configure agent 210 to accurately predict the optimal action for a given state of a debtor 101, agent 210 may be trained using reinforcement learning techniques. Since the optimal action for a given debtor's situation or state is often not known (or would be difficult to accurately determine), there is not likely to be readily available training data that would be effective in training a supervised learning model to predict an optimal action for a debtor 101 in a given state. However, reinforcement learning techniques can be used to train agent 210 to choose actions that maximize rewards that are defined according to a reward structure. Preferably, rewards in the reward structure are defined in a way that causes agent 210 to choose an action that is optimal for a given state, where optimal tends to involve actions that are productive in collecting a delinquent debt.

For example, reward structure 242 outlines one possible structure for granting rewards to agent 210. In FIG. 2A, agent 210 may take any of a variety of actions (i.e., call, email, text) to attempt to cause a debtor 101 to make a payment on a delinquent account. In reward structure 242, if an action taken by agent 210 results in payment being made by a debtor within two days, agent 210 receives a reward of 100 points. If an action taken by agent 210 results in the debtor initiating contact about the debt with the bank or other creditor (but not paying the debt), agent 210 receives a reward of 30 points. If an action taken by agent 210 results in the debtor logging into an online account (e.g., to check the status of his or her account), agent 210 receives a reward of 5 points. If none of these outcomes result from an action taken by agent 210, the agent is penalized 1 point.

Agent 210 is trained to choose the optimal action in each state, as defined by the expected reward resulting from the selected action. The optimal action is defined by an optimal value function (sometimes known as a “Q function”). In some cases, an optimal value function can be conceptually represented by a Q table (e.g., Q table 243), which lists expected reward values for each state/action pair.

To train agent 210, agent 210 might be initially configured to choose random actions when presented with debtors 101 in various states (e.g., Q table 243 is generated with random numbers initially, or all zeros). After each random action, the effect of the action on environment 220 is observed and information about that effect can be saved for later use. Specifically, for each action taken by agent 210 when presented with a given state, the effect of that action on environment 220 and the reward that results can be observed and assembled into experience data 231. Experience data 231 may therefore be a data structure that includes a set of information describing an action taken by agent 210 and the effect that the action has on environment 220. Typically, in reinforcement learning, experience data 231 includes the current state S(t), the action A(t) taken by agent 210, the reward R(t) received by agent 210 in the current state, the next state S(t+1), and a termination flag. Since the action taken by agent 210 affects environment 220 and/or changes the state of the underlying debtor 101, it moves the debtor 101 into a new, different state S(t+1). In some cases, the action results in a termination condition, meaning that the objective of the agent has been completed. In the context of this disclosure, a termination condition might be that payment has been received from the debtor, or that the agent has concluded that the debtor will not pay, so no further efforts to communicate with the debtor should be made. The termination flag, which may be included within experience data 231, identifies experiences that result in a termination condition. Each instance of experience data 231 is stored in experience buffer 232.

By observing agent 210 repeatedly taking actions (e.g., random actions) with respect to debtors 101 in varying states, and observing the effect (e.g., rewards) that those actions have on environment 220, experience data 231 can be collected that provides insights into how actions taken in various states translate into rewards pursuant to reward structure 242. This stored experience data 231 can then be used to train or retrain agent 210 to choose an action for a given state that tend to maximize those rewards. Reinforcement learning, as described herein, involves progressively updating the values in Q table 243 (often implemented as a neural network) in a way that tends to improve, over time, the ability of agent 210 to choose optimal actions (e.g., actions that tend to maximize rewards from reward structure 242).

For example, in FIG. 2A agent update process 230 may, after collecting sufficient experience data 231, update agent 210 using stored experience data 231 in experience buffer 232. Agent update process 230 accesses experience data 231 in buffer 232 and determines the rewards that result from actions taken in various states. Agent update process 230 trains a neural network to predict an expected reward for each of the actions that could be taken when for a given state. To make this prediction, the neural network generates an expected optimal value or expected return (sometimes known as a “Q value”) for various actions in given states. Q table 243, shown in FIG. 2A, is an example representation of the Q values generated by the neural network for each action in each state (Q table values of “0” indicate no historical data for that state/action pair). Each Q value within Q table 243 represents the maximum expected future reward for each action that can be taken in a given state. For each possible state (e.g., states 0 through 383), available actions (email, text, or push contacts) have an associated value or expected return. When presented with a state, agent 210 uses Q table 243 to choose an optimal action for a given state, typically by identifying the action having the highest return (e.g., for state 1, agent 210 would tend to choose the “email” action).

Once agent update process 230 generates an updated Q table 243 from the experience data 231 in experience buffer 232, agent update process 230 updates agent 210 with the newly trained neural network (e.g., replacing the prior neural network used by agent 210). Thereafter, when agent 210 is presented with a state of a debtor, agent 210 uses the newly trained neural network to predict, based on the state information about the debtor, the optimal action to take. In other words, for each state, agent 210 predicts, using Q table 243, the expected return value for each of the actions that could be taken in a given state. Typically, agent 210 will choose the action having the highest expected return, and then perform the action.

Although in most instances agent 210 will choose the action having the highest expected return, agent 210 may also occasionally choose a random action, to ensure that at least some experience data 231 is collected that enables the model to evolve and avoid local optima. Specifically, while agent 210 may apply an epsilon-greedy policy (e.g., 5%) so that the action with the highest expected return is chosen often, agent 210 may nevertheless balance exploration and exploitation of available data by occasionally choosing a random action rather than the action having the highest expected return.

After performing each action, the effect on environment 220 is observed and saved within experience buffer 232 as a new instance of experience data 231, thereby eventually resulting a new collection of stored experience data 231. The process may continue, with agent 210 making predictions, performing actions, and the resulting new experience data 231 being stored within experience buffer 232.

After sufficient new experience data 231 is collected within experience buffer 232, agent update process 230 may again retrain the model that agent 210 uses to make predictions. For example, agent update process 230 collects the new experience data 231 from experience buffer 232 and retrains the previous neural network (e.g., augmenting prior training data by incorporating the new experience data 231). Agent update process 230 again updates the neural network used by agent 210 with the newly trained neural network. Thereafter, agent 210 uses the new neural network to choose the next best communication channel to use for a given debtor 101.

Over time, by collecting new experience data 231 and retraining the model underlying agent 210 with the new data, the skill with which agent 210 predicts actions that optimize future rewards will improve. Eventually, agent 210 will arrive at an action selection policy that tends to optimize the rewards received pursuant to reward structure 242, and thereby optimize selection of those actions that increase the odds of collecting a delinquent debt.

FIG. 2B is a flow diagram illustrating an example process for performing reinforcement learning tasks described in connection with FIG. 2A, in accordance with one or more aspects of the present disclosure. In the example of FIG. 2B, the illustrated process may be performed by system 200 in the context illustrated in FIG. 2A. The process of FIG. 2B is illustrated from two different perspectives: operations performed by an example agent 210 (left-hand column to the left of dashed line), and operations performed by an example agent update process 230 (right-hand column to the right of dashed line). In other examples, different operations may be performed, or operations described in FIG. 2B as being performed by a particular component, module, system, and/or device may be performed by one or more other components, modules, systems, and/or devices. Further, in other examples, operations described in connection with FIG. 2B may be performed in a difference sequence, merged, omitted, or may encompass additional operations not specifically illustrated or described even where such operations are shown performed by more than one component, module, system, and/or device.

In the process illustrated in FIG. 2B, and in accordance with one or more aspects of the present disclosure agent 210 may apply a model to choose a contact channel (251). For example, agent 210, in response to being presented with state information for a specific delinquent debtor, uses Q table 243 to identify the action having the highest expected future reward, based on the values in Q table 243. In one example, agent 210 might determine that “email” is the contact channel with the highest expected future reward, based on reward structure 242.

Agent 210 may initiate contact (252). For example, agent 210 causes an email to be sent to the debtor associated with the state information previously presented to 210. In some examples, agent 210 interacts with other computing systems to cause such other computing systems (e.g., contact system 150) to contact the debtor via email.

Agent 210 may observe the effect on the environment (253). For example, agent 210 monitors the debtor's account to determine whether the debtor has paid the balance of the delinquent account. Agent 210 may also monitor communications to determine whether the debtor has responded to the email. Eventually, after the reward horizon has passed (e.g., two days), agent 210 determines what effect the email had on environment 220, if any.

Agent update process 230 may save information about the experience (257). For example, agent update process 230 collects information about the effect that sending the email had on environment 220. Agent update process 230 saves the information as experience data 231 that includes information about the state of the debtor, action taken (i.e., email), the reward received by agent 210, the next state, and whether the episode has terminated (e.g., debt was collected).

Agent 210 may update its state (254). For example, agent 210 determines, based on the effect that its action had on environment 220, a new state. Even if no response to the email was received, the debtor and/or environment 220 will still advance to a new state, at least because the prior email will change the state information pertaining to past contact attempts associated with the debtor.

Agent 210 may determine whether a termination state has been reached (255). If the debtor paid his or her debt, then likely no further communication action is needed, and a post-processing system (not shown in FIG. 2A) can be used to finish the collection and finalize the episode (256 and YES path from 255). Also, environment 220 may also reach a termination state if there have been enough communications with the debtor such that it is no longer productive to keep contacting the debtor about payment (i.e., a loss write-off). In such an example, the debtor can be passed to another post-processing system which may write-off the debt as a loss. If a termination state has not been reached, the process repeats, with agent 210 again choosing an action, this time based on the new state of the debtor (NO path from 255).

Agent update process 230 may retrain the model that chooses contact channels (258). For example, agent update process 230 collects the set of experience data 231 that has been stored in experience buffer 232. Agent update process 230 retrains a neural network using the data, updating the model previously used by agent 210. Agent update process 230 deploys the updated neural network to agent 210, thereby causing agent 210 to thereafter apply the retrained model when choosing contact channels. This update process may continue indefinitely, updating the neural network used by agent 210, and thereby improving the ability of agent 210 to choose the next best communication channel to use when contacting a given debtor. The update process can be performed on any appropriate schedule, iso that agent update process 230 retrains the model used by agent 210 occasionally, periodically, or even continually.

In some applications of reinforcement learning, environment 220 is a simulated environment and the agent is implemented as a computing system that interacts with the simulated environment 220. In such an example, environment 220 might be a video game, and agent 210 may be a simulated user playing the video game, where the actions selected by agent 210 correspond to game-playing options available to the user (e.g., joystick or controller inputs). In another example, environment 220 might be a vehicle motion simulation environment, and agent 210 may be a simulated driver or vehicle that navigates to a desired location within the simulation environment. In this latter example, actions selected by agent 210 may correspond to vehicle control actions (e.g., braking, steering, accelerating).

In other implementations of reinforcement learning, including at least some of the implementations described herein, the environment is a real-world or production environment, where the agent selects actions that affect that the real-world environment. For example, agent 210 may choose actions that translate into real-world attempts to contact actual debtors 101 over actual communication channels. Those actions have real-world effects on environment 220, and those effects are observed, assembled into experience data 231, and stored within experience buffer 232.

For reinforcement learning systems that learn in a real-world environment or production environment, it may be inappropriate to initially configure agent 210 to choose random actions, since the effect of those actions may be counterproductive real-world effects. Accordingly, although agent 210 may be initially configured to choose random actions so that it can learn an appropriate reward-maximizing policy without any biases, a different approach may be preferred for production environments. For instance, system 100 might use a batch reinforcement learning approach, which uses historical data for initial training. In such an example, agent 210 is initially trained using a fixed batch of data, without exploration (i.e., maximally exploiting an initial data set assembled from historical data). Such an approach may enable agent 210 to make action predictions that are sufficiently accurate or competent to be used in a real-world environment from the start.

FIG. 2C is a flow diagram illustrating an example process for initial training of agent 210, in accordance with one or more aspects of the present disclosure. The process of FIG. 2C involves accessing an analytic-ready set of data, which could be derived from historical information about conventional or human-chosen attempts to contact debtors, and the timing and different approaches to contacting debtors that have performed historically, such as indicated by prevailing best practices. Preprocessing may be performed on such data, converting it into data having the form of experience data 231, similar to that used in connection with FIG. 2A. Using the pre-processed data, the initial model underlying agent 210 may be trained using Q-Learning approaches. Optimizations relating to how states are selected and various reinforcement learning settings may be made, resulting in a reinforcement model that may be appropriate for production use. Such a model may be refined and improved, over time, using the techniques described in connection with FIG. 2A and FIG. 2B.

FIG. 2D is a flow diagram illustrating an example periodic process (e.g., daily) for updating agent 210, in accordance with one or more aspects of the present disclosure. In the example of FIG. 2D, the illustrated process may be performed by agent update process 230 in the context illustrated in FIG. 2A. For instance, agent update process 230 collects experience data 231 from experience buffer 232 and performs any preprocessing that still has not yet been performed on experience data 231. Agent update process 230 then filters data associated with actions taken more than two days ago. In the example being described, newer data (less than two days old) is not used for retraining agent 210, since data associated with actions taken more recently than two days ago may still have an effect on environment 220. In other words, the reward for such actions might not be known until two days have passed (according to reward structure 242, rewards are granted for events happening up to two days after an action is taken). Agent update process 230 then retrains the model underlying agent 210, thereby updating Q table 243. In some examples, experience data 231 may be retained on a rolling basis, such as over a period of the most recent seven months or so, and Q table 243 may be updated using the prior seven months of collected data. Other time or date ranges may be used, however.

FIG. 2E is a flow diagram illustrating an example periodic process (e.g., daily) for choosing an action to take for each debtor, in accordance with one or more aspects of the present disclosure. In the example of FIG. 2E, the illustrated process may be performed by agent 210 in the context illustrated in FIG. 2A. For instance, agent 210 filters experience data 231 within experience buffer 232 for the latest date, to ensure that agent 210 is operating on the most recent state information for each debtor. Agent 210 predicts, for each debtor and based on the current state for that debtor, an expected future reward (i.e., a “score”) associated with each possible action that could be taken (email, text, notification, etc.). To generate the expected future reward, agent 210 may perform a lookup using Q table 243. In some examples, agent 210 may, for some small fraction of predictions, generate random score(s) or other otherwise inject randomness into the action selection process, pursuant to an epsilon-greedy policy. Such randomness ensures that some exploration is performed by agent 210 when selecting actions to take, thereby enabling the model to evolve and learn the effect of previously-untried actions for a given state.

After generating a score for each debtor, agent 210 translates the scores (i.e., corresponding expected future rewards taken from Q table 243 into a single-digit number ranging from 0 to 9. Agent 210 generates output table 245 that includes, by a customer or debtor number, the translated single-digit scores for each debtor and for each possible action.

In output table 245, the first column represents a unique identifier for the debtor associated with each row. The second column is a 10-character string, where the first digit represents the score for an email communication action, the second digit represents the score for a text messaging communication action, and the third digit represents the score for a push notification action. As described, single-digit scores in output table 245 are obtained by normalizing Q-table values. Generally, in output table 245, the higher the score, the higher is the preference to use that channel. Additional characters are for additional channels that may be used (represented by ‘X’). The third column in output table 245 represents a flag indicating whether the scores are generated by either choosing the highest expected reward (exploit) or randomly (explore).

Techniques described herein may provide certain technical advantages. For example, by using reinforcement learning to train a model to select the right communication channel to use to communicate with a debtor, systems described herein not only maximize the chance of obtaining payment for a debt, but also reduce the amount of communications and processing needed to obtain payment. At least some processing that would otherwise need to be performed when uncollectable debts were previously identified could also be avoided.

Further, selecting the optimal communication channel tends to decrease debtor contact cost and avoid debtor fatigue that may result from contacting debtors through multiple channels at the same time. Techniques described herein improve bank customer, credit customer, and/or lending customer satisfaction by using the most appropriate communication channel at the right time, thereby driving better penetration towards payment. Further, such techniques tend to help maintain creditors' positive relationships with customers and debtors, and thereby maintain the positive reputation of the creditor.

Techniques described herein may increase the percentage of delinquent debtors who are contacted and who then pay their debt, and thereby decrease the amount of debt that needs to be written off or characterized as uncollectible. Such techniques may decrease the amount of time a debtor spends in delinquency, since more efficient communication targeting using the preferred channel will tend to reduce delinquency timeframes. The described techniques may decrease contact operational costs, due to fewer outbound calls or other communications being made per debtor.

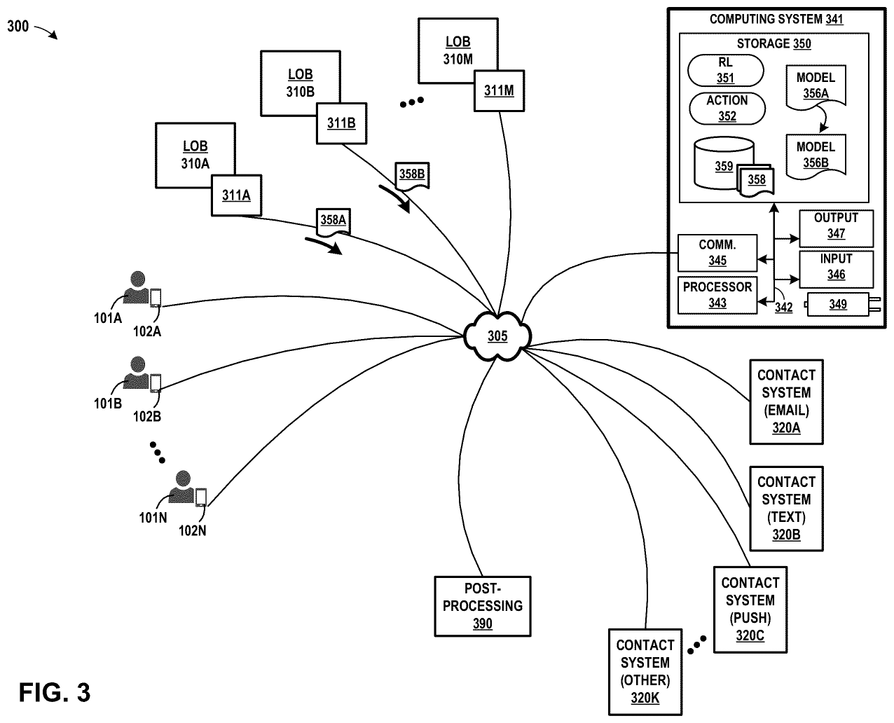

FIG. 3 is a block diagram illustrating an example system for communicating with borrowers, lending customers, credit customers, and/or debtors in an appropriate manner, in accordance with one or more aspects of the present disclosure. System 300 includes debtors 101 (101A through 101N), each with a corresponding debtor device 102 (102A through 102N). Each of debtors 101 may be a customer of one or more commercial entities or businesses, and may hold a debt associated with such businesses. In FIG. 3, those commercial entities are illustrated as lines of business 310A through 310M, which may represent lines of business within the same bank or financial institution. For example, line of business 310A may correspond to a credit card branch of a bank, line of business 310B may correspond to a lending branch of the same bank, and line of business 310M may correspond to a different branch of a bank that extends credit to customers. Although described herein as lines of business 310 of a bank, each such line of business 310 may, in other examples, be a separately-operated bank, financial institution, or other business. Each of line of business 310 controls or operates one or more computing systems 311 (e.g., computing system 311A is controlled or operated by line of business 310A, computing system 311B is controlled or operated by line of business 310B). Each of computing systems 311 may be used in debt collection operations for a specific line of business 310.

Also included in system 300 of FIG. 3 are various systems for contacting and/or communicating with debtors 101 (or with debtor devices 102 operated by debtors 101). Such systems include contact system 320A (e.g., for email communications with debtors 101), contact system 320B (e.g., for text messaging), contact system 320C (e.g., for push notifications). Additional contact systems 320 (e.g., contact system 320K) may be used for other communications channels. Collectively, contact systems 320 may generally correspond to contact system 150 of FIG. 1. Similarly, post-processing system 390, also illustrated in FIG. 3, may be a system that performs functions generally corresponding to functions performed by collection system 160 of FIG. 1 and/or special collections system 170 of FIG. 1. All of the illustrated systems are capable of communicating over network 305. Network 305 may be any public or private network, and may be or may include the internet.

FIG. 3 also includes computing system 341, illustrated as a block diagram with specific components and functional modules. In examples described in connection with FIG. 3, computing system 341 may correspond to, or may be considered an example or alternative implementation of one or more computing systems used to implement system 100 of FIG. 1 or system 200 of FIG. 2A.

For ease of illustration, computing system 341 is depicted in FIG. 3 as a single computing system. However, in other examples, computing system 341 may comprise multiple devices or systems, such as systems distributed across a data center or multiple data centers. For example, separate computing systems may implement functionality performed by each of reinforcement learning module 351 or action module 352, described below. A separate system could also be used to train one or more models 356. Alternatively, or in addition, computing system 341 (or various modules illustrated in FIG. 3 as included within computing system 341) may be implemented through distributed virtualized compute instances (e.g., virtual machines, containers) of a data center, cloud computing system, server farm, and/or server cluster.

Also, although FIG. 3 illustrates various systems separately, some of such systems may be combined or included within functionality performed by computing system 341. For example, computing systems included within one or more computing systems 311 may be integrated into computing system 341. Alternatively, or in addition, computing systems described as part of one or more contact systems 320 may be integrated into computing system 341. Further, some or all aspects of post-processing system 390 may be integrated into or performed by computing system 341.

In FIG. 3, computing system 341 is illustrated as including underlying physical hardware that includes power source 349, one or more processors 343, one or more communication units 345, one or more input devices 346, one or more output devices 347, and one or more storage devices 350. Storage devices 350 may include reinforcement learning module 351 and action module 352. These modules may apply and/or generate one or more models 356, such as by using reinforcement learning techniques. Storage devices 350 may also include data store 359. In some examples, data store 359 may be used to store data about experiences or state transitions performed by computing system 341 within system 300. In such examples, data store 359 may include what is sometimes known as an experience replay buffer.

One or more of the devices, modules, storage areas, or other components of computing system 341 may be interconnected to enable inter-component communications (physically, communicatively, and/or operatively). In some examples, such connectivity may be provided by through communication channels, which may include a system bus (e.g., communication channel 342), a network connection, an inter-process communication data structure, or any other method for communicating data.

Power source 349 of computing system 341 may provide power to one or more components of computing system 341. One or more processors 343 of computing system 341 may implement functionality and/or execute instructions associated with computing system 341 or associated with one or more modules illustrated herein and/or described below. One or more processors 343 may be, may be part of, and/or may include processing circuitry that performs operations in accordance with one or more aspects of the present disclosure. One or more communication units 345 of computing system 341 may communicate with devices external to computing system 341 by transmitting and/or receiving data, and may operate, in some respects, as both an input device and an output device. In some or all cases, communication unit 345 may communicate with other devices or computing systems over network 305 or over other networks.

One or more input devices 346 may represent any input devices of computing system 341 not otherwise separately described herein, and one or more output devices 347 may represent any output devices of computing system 341 not otherwise separately described herein. Input devices 346 and/or output devices 347 may generate, receive, and/or process output from any type of device capable of outputting information to a human or machine. For example, one or more input devices 346 may generate, receive, and/or process input in the form of electrical, physical, audio, image, and/or visual input (e.g., peripheral device, keyboard, microphone, camera). Correspondingly, one or more output devices 347 may generate, receive, and/or process output in the form of electrical and/or physical output (e.g., peripheral device, actuator).

One or more storage devices 350 within computing system 341 may store information for processing during operation of computing system 341. Storage devices 350 may store program instructions and/or data associated with one or more of the modules described in accordance with one or more aspects of this disclosure. One or more processors 343 and one or more storage devices 350 may provide an operating environment or platform for such modules, which may be implemented as software, but may in some examples include any combination of hardware, firmware, and software. One or more processors 343 may execute instructions and one or more storage devices 350 may store instructions and/or data of one or more modules. The combination of processors 343 and storage devices 350 may retrieve, store, and/or execute the instructions and/or data of one or more applications, modules, or software. Processors 343 and/or storage devices 350 may also be operably coupled to one or more other software and/or hardware components, including, but not limited to, one or more of the components of computing system 341 and/or one or more devices or systems illustrated or described as being connected to computing system 341.

In operation, and in accordance with one or more aspects of the present disclosure, computing system 341 may train an initial model to select the next best contact channel for delinquent debtors. For instance, in an example that can be described in the context of FIG. 3, communication unit 345 outputs a signal over network 305. One or more computing systems 311 detect a signal and determine that the signal corresponds to a request for historical information about legacy collection practices and communications associated with such practices. Each of computing systems 311 output responsive signals over network 305. Communication unit 345 of computing system 341 detect responsive signals and output information about the signals to reinforcement learning module 351. Reinforcement learning module 351 processes the information and stores the processed information as experience data 358 within data store 359. Each instance of experience data 358 may have a form similar to experience data 231 of FIG. 2A. Reinforcement learning module 351 trains a neural network to predict an expected reward as a function of a debtor state and action. The resulting neural network (e.g., model 356A) can be used as an initial model for selecting a next action (e.g., next best contact channel) for contacting delinquent debtors 101.

Computing system 341 may identify the next best communication channel to use when contacting one of debtors 101. For instance, continuing with the example being described in the context of FIG. 3, line of line of business computing system 311A outputs a signal over network 305. Communication unit 345 of computing system 341 detects the signal over network 305 and outputs information about the signal to reinforcement learning module 351. Reinforcement learning module 351 determines that the signal corresponds to a request to identify the next best communication channel that should be used to contact delinquent debtor 101A, who may be a customer of line of business 310A. Reinforcement learning module 351 further determines that the request includes information about the state of debtor 101A (e.g., state information identified in state definition 241 of FIG. 2A). Reinforcement learning module 351 applies model 356A to the state information for debtor 101A. Model 356A determines, for each available channel, a score that corresponds to the likelihood of that channel resulting in a maximized expected reward. Model 356A may generate a string similar to that shown in the “score” column of output table 245 in FIG. 2D.

Computing system 341 may enable one of contact systems 320 to communicate with debtor 101A. For instance, still continuing with the example being described in the context of FIG. 3, reinforcement learning module 351 causes communication unit 345 to output a signal over network 305. Line of business computing system 311A detects a signal and determines that the signal corresponds to a response to the request to identify the next best action that should be taken to contact delinquent debtor 101A. Line of business computing system 311A evaluates the response, which may include information corresponding to output table 245, to identify the best channel to use when contacting debtor 101A. Line of business computing system 311A may apply one or more filters to the channels (e.g., subscription lists, “do not contact” lists, regulatory requirements, policies specific to a line of business), which may affect which channel is selected for contacting debtor 101A. In some examples, if a filter indicates that the best channel should not be used, the second-best channel may be used instead. Line of business computing system 311A determines, based on the responsive information received from computing system 341 and application of any filters, that email is the channel that should be used for contacting debtor 101A. In some examples, each line of business 310 may make the final selection of which communication channel should be used in a given situation, and may override (e.g., based on filtering) predictions made by computing system 341. Accordingly, line of business computing system 311A outputs a signal over network 305 to contact system 320A. Contact system 320A receives the signal and uses information included within the signal to initiate contact with debtor 101A through an email channel.

Computing system 341 may receive information about the effect that communicating with debtor 101A had on the environment. For instance, again continuing with the example, and after the email is sent to debtor 101A, contact system 320A may eventually receive a response from debtor 101A, or may observe that debtor 101A has paid the balance due for the delinquent account. After a sufficient amount of time has passed (e.g., a reward horizon), contact system 320A generates data about its attempts to contact debtor 101A, including information sufficient to determine what rewards, if any, might apply to the experience (e.g., pursuant to reward structure 242). Contact system 320A outputs the data over network 305 to line of business computing system 311A. Line of business computing system 311A receives the data and uses the data to generate experience data 358A. In cases where a filter applied by line of business computing system 311A modifies the channel selected by model 356A for contacting debtor 101A, experience data 358A reflects the actual channel used to contact debtor 101A, rather than any different top-ranked channel that might have been identified as optimal by model 356A. Line of business computing system 311A outputs experience data 358A over network 305 to computing system 341. Computing system 341 receives the experience data, and reinforcement learning module 351 of computing system 341 stores experience data 358A within data store 359.

Computing system 341 may make similar predictions for other lines of business 310. For instance, again with reference to FIG. 3, line of business computing system 311B outputs a signal over network 305 to computing system 341. Reinforcement learning module 351 of computing system 341 interprets the signal as a request, by line of business 310B, to identify the next best action that should be taken to contact debtor 101B, which may be a customer of line of business 310B, and where debtor 101B may have a delinquent account with line of business 310B. Reinforcement learning module 351 applies model 356A to state information for debtor 101B and causes communication unit 345 to output information over network 305 to line of business computing system 311B. Line of business computing system 311B receives the information and determines that the information includes information about debtor 101B in a form similar to a row of output table 245. Line of business computing system 311B applies any applicable filters, and determines that debtor 101B should be contacted through a text message. Line of business computing system 311B thereafter communicates with contact system 320B, causing contact system 320B to contact debtor 101B through a text message. Contact system 320B reports the results of the contact experience to line of business computing system 311B, and line of business computing system 311B sends experience data 358B to computing system 341 over network 305. Computing system 341 stores experience data 358B in data store 359.

Computing system 341 may use collected experience data 358 to update model 356A. For instance, once again with reference to the example being described in the context of FIG. 3, reinforcement learning module 351 accesses experience data 358 from data store 359 (e.g., including experience data 358A received from line of business computing system 311A and experience data 358B received from line of business computing system 311B). Reinforcement learning module 351 retrains model 356A using data accessed from data store 359, which at least includes recent instances of experience data 358 drawn from recent next best channel recommendations made for each of line of business 310. Reinforcement learning module 351 generates model 356B based on the retraining, which results in updated values in a Q table (e.g., Q table 243). Thereafter, when computing system 341 receives a request from one of computing system 311 to select the next best communication channel to contact a given debtor 101, reinforcement learning module 351 applies model 356B.

This process of collecting new experience data 358 and retraining a prior model 356 may take place repeatedly, each time resulting in an updated model 356 being placed into production in computing system 341 of system 300. Over time, this repeated process will tend to improve the skill of model 356 in choosing the appropriate channel to contact debtors 101, and may result in a model having a level of skill that exceeds even human experts having skill in selecting an appropriate communication channel to use when contact debtors 101. In some examples, this process of updating model 356 may take place periodically, such as on a daily basis. However, in other examples, the process may take place at any appropriate time, and may take place occasionally, periodically, or continually.

Further, in some examples, in addition to identifying the next best contact channel to use, model 356 may also be trained to identify the most appropriate time of day to send the message to a given debtor 101 (morning/afternoon/night) on the optimal contact channel. In still other examples, model 356 may also be trained to generate a specific message with actual content that should be included within the message to a given debtor 101 (e.g., the text of an email or a proposed transcript for a phone call).

Modules illustrated in FIG. 3 (e.g., reinforcement learning module 351, action module 352) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

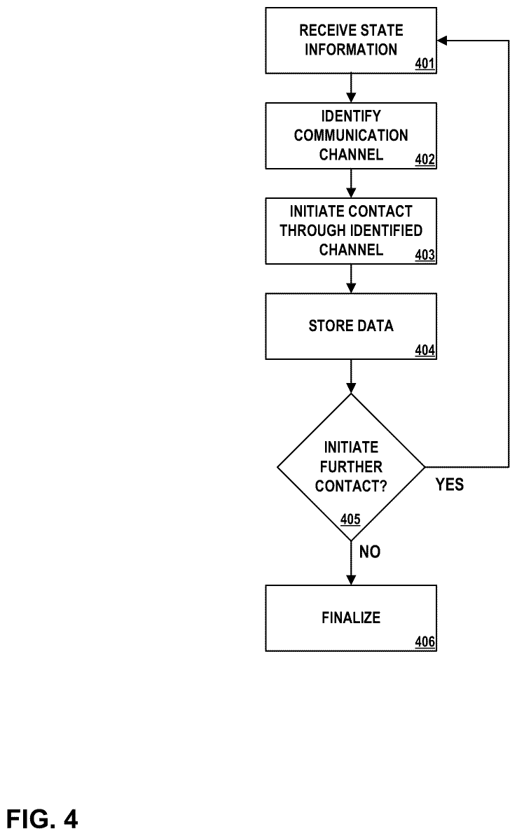

FIG. 4 is a flow diagram illustrating operations performed by an example computing system in accordance with one or more aspects of the present disclosure. FIG. 4 is described below within the context of system 200 of FIG. 2A. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, system 200 may receive state information (401). For example, with reference to FIG. 2A, agent 210 receives a request, from a creditor, to identify the most appropriate communication channel to use for contacting a specific debtor. Included in the request is information sufficient to identify the current state of the debtor, as defined by state definition 241.

System 200 may identify a communication channel (402). For example, again with reference to FIG. 2A, agent 210 uses the current state information to identify the expected reward for each of a number of ways in which debtor might be contacted. In some examples, agent 210 uses Q table 243 to identify optimal values for each possible communication action that can be taken for the state associated with the debtor. Agent 210 identifies the communication channel that has the highest expected reward, as defined by reward structure 242.

System 200 may initiate contact through the identified channel (403). For example, agent 210 initiates a communication (or causes another system to initiate a communication) with the debtor using the identified communication channel. Agent 210 awaits a response to the communication, and monitors the debt balance to determine whether the debtor may have paid the balance.

System 200 may store data (404). For example, after sufficient amount of time passes (e.g., the reward horizon), agent 210 determines whether any response to the communication was sent by the debtor and/or whether the debt was paid. Agent 210 thereby determines the effect of the communication on environment 220 and determines the next state. Agent 210 assembles information about the communication and its effect on environment 220 as experience data 231. Agent 210 stores experience data 231 within experience buffer 232.

System 200 may determine whether to initiate further contact (405). Agent 210 determines whether a termination condition has been satisfied, such as the debt being paid, or the debtor being classified as uncollectible.

System 200 may finalize collection (406). If agent 210 determines that a termination condition has been reached, then the debt collection process is finalized (NO path from 405). If agent 210 determines that no termination condition has been reached, agent 210 uses the new state to identify the next best communication channel to contact the debtor (YES path from 405).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any such disclosure material that is incorporated by reference conflicts with the present disclosure, the present disclosure shall control.

For ease of illustration, a limited number of devices or systems (e.g., debtor devices 102, computing systems 311, computing system 341, contact systems 320, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures.

In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
receiving, by a computing system, state information for a debtor, wherein the state information includes information about delinquency history for the debtor and prior efforts to contact the debtor to collect a delinquent debt;
identifying, by the computing system and based on the state information for the debtor, a communication channel to use to contact the debtor about the delinquent debt, wherein the communication channel is one of a plurality of communication channels that could be used to contact the debtor;
initiating contact with the debtor, by the computing system, through the identified communication channel;
storing, by the computing system, data identifying how the debtor reacted to the initiated contact through the identified communication channel; and
determining, by the computing system, whether to initiate further communications with the debtor about the delinquent debt.

2. The method of claim 1, wherein the identified communication channel is a first communication channel, wherein determining whether to initiate further communications includes determining that further communications are required, and wherein the method further comprises:
determining, by the computing system and based on how the debtor reacted to the initiated contact through the first communication channel, a next state associated with the debtor;
identifying, by the computing system and based on the next state associated with the debtor, a second communication channel to use to contact the debtor about the delinquent debt, wherein the second communication channel is one of the plurality of communication channels but is different than the first communication channel;
initiating an additional contact with the debtor, by the computing system, through the second communication channel; and
storing data, by the computing system, identifying how the debtor reacted to the initiated additional contact through the second communication channel.

3. The method of claim 1, wherein identifying the communication channel includes:
applying a reinforcement learning model to identify a communication channel that has a higher expected reward, as defined by a reward structure, than any other of the plurality of communication channels.

4. The method of claim 3, further comprising:
retraining, by the computing system, the reinforcement learning model using the stored data identifying how the debtor reacted to the initiated contact through the identified communication channel, wherein retraining the reinforcement learning model improves the skill of the reinforcement learning model in identifying communication channels having a high expected reward as defined by the reward structure.

5. The method of claim 4, wherein identifying the communication channel includes:
filtering the plurality of communication channels to take into account restrictions on contacting at least one debtor through at least one of the plurality of communication channels.

6. The method of claim 5, wherein retraining the reinforcement learning model includes:
adjusting the data used to retrain the reinforcement learning model based on the filtering.

7. The method of claim 5, wherein filtering the plurality of communication channels includes:
enabling another entity to filter the plurality of communication channels and exercise control over which of the plurality of communication channels are used to contact the debtor.

8. The method of claim 3, further comprising:
initially training the reinforcement learning model using historical data and a batch reinforcement learning approach.

9. The method of claim 1, wherein identifying a communication channel includes:
identifying, multiple times over the course of a week, a communication channel to use to contact each of a plurality of delinquent debtors.

10. The method of claim 1, wherein determining whether to initiate further communications with the debtor about the delinquent debt includes:
determining that the debtor has paid the delinquent debt.

11. A computing system comprising processing circuitry and a storage device, wherein the processing circuitry has access to the storage device and is configured to:
receive state information for a debtor, wherein the state information includes information about delinquency history for the debtor and prior efforts to contact the debtor to collect a delinquent debt;
identify, based on the state information for the debtor, a communication channel to use to contact the debtor about the delinquent debt, wherein the communication channel is one of a plurality of communication channels that could be used to contact the debtor;
initiate contact with the debtor through the identified communication channel;
store data identifying how the debtor reacted to the initiated contact through the identified communication channel; and
determine whether to initiate further communications with the debtor about the delinquent debt.

12. The computing system of claim 11, wherein the identified communication channel is a first communication channel, wherein to determine whether to initiate further communications, the processing circuitry determines that further communications are required, and wherein the processing circuitry is further configured to:
determine, based on how the debtor reacted to the initiated contact through the first communication channel, a next state associated with the debtor;
identify, based on the next state associated with the debtor, a second communication channel to use to contact the debtor about the delinquent debt, wherein the second communication channel is one of the plurality of communication channels but is different than the first communication channel;
initiate an additional contact with the debtor through the second communication channel; and
store data identifying how the debtor reacted to the initiated additional contact through the second communication channel.

13. The computing system of claim 11, wherein to identify the communication channel, the processing circuitry is further configured to:
apply a reinforcement learning model to identify a communication channel that has a higher expected reward, as defined by a reward structure, than any other of the plurality of communication channels.

14. The computing system of claim 13, wherein the processing circuitry is further configured to:
retrain the reinforcement learning model using the stored data identifying how the debtor reacted to the initiated contact through the identified communication channel, wherein retraining the reinforcement learning model improves the skill of the reinforcement learning model in identifying communication channels having a high expected reward as defined by the reward structure.

15. The computing system of claim 14, wherein to identify the communication channel, the processing circuitry is further configured to:
filter the plurality of communication channels to take into account restrictions on contacting at least one debtor through at least one of the plurality of communication channels.

16. The computing system of claim 15, wherein to retrain the reinforcement learning model, the processing circuitry is further configured to:
adjust the data used to retrain the reinforcement learning model based on the filtering.

17. The computing system of claim 15, wherein to filter the plurality of communication channels, the processing circuitry is further configured to:
enable another entity to filter the plurality of communication channels and exercise control over which of the plurality of communication channels are used to contact the debtor.

18. The computing system of claim 13, wherein the processing circuitry is further configured to:
initially train the reinforcement learning model using historical data and a batch reinforcement learning approach.

19. The computing system of claim 11, wherein to identify a communication channel, the processing circuitry is further configured to:
identify, multiple times over the course of a week, a communication channel to use to contact each of a plurality of delinquent debtors.

20. A non-transitory computer-readable medium comprising instructions that, when executed, configure processing circuitry of a computing system to:
receive state information for a debtor, wherein the state information includes information about delinquency history for the debtor and prior efforts to contact the debtor to collect a delinquent debt;
identify, based on the state information for the debtor, a communication channel to use to contact the debtor about the delinquent debt, wherein the communication channel is one of a plurality of communication channels that could be used to contact the debtor;
initiate contact with the debtor through the identified communication channel;
store data identifying how the debtor reacted to the initiated contact through the identified communication channel; and
determine whether to initiate further communications with the debtor about the delinquent debt.
